(19) United States
(12) Patent Application Publication
(10) Pub. No.: US 2026/0128270 A1
(43) Pub. Date: May 7, 2026

(54) FIXTURES AND DEVICES FOR USE IN ISOELECTRIC FOCUSING-MASS SPECTROMETRY

(71) Applicant: INTABIO, LLC, Fremont, CA (US)

(72) Inventors: Greg Bogdan, Fremont, CA (US); Alexander Petrov, Fremont, CA (US); Glenn White, Fremont, CA (US); Hongfeng Yin, Fremont, CA (US)

(21) Appl. No.: 19/117,588

(22) PCT Filed: Oct. 13, 2023
(86) PCT No.: PCT/US2023/076842

§ 371 Date: Apr. 1, 2025

Related U.S. Application Data
(60) Provisional application No. 63/418,364, filed on Oct. 21, 2022.
(60) Provisional application No. 63/430,405, filed on Dec. 6, 2022.

(51) Int. Cl. H01J 49/16

(52) U.S. Cl. CPC H01J 49/167

(57) ABSTRACT

The described and claimed technology includes a fixture for applying and/or maintaining positive pressure in an electrode reservoir and related methods for pressurizing an electrode reservoir.

### RELATED APPLICATIONS

The present patent application claims the priority benefit of U.S. Provisional Patent Application Ser. No. 63/418,364, filed Oct. 21, 2022 and U.S. Provisional Patent Application Ser. No. 63/430,405, filed Dec. 6, 2022, the content of each is hereby incorporated by reference in its entirety into this disclosure.

### BACKGROUND

In isoelectric focusing, a biologic sample, such as a protein sample, is mixed with an ampholyte solution. This sample/ampholyte solution is then pushed into a capillary or a capillary channel. One end of the channel is then connected to an anolyte solution (generally an acidic solution) and the other end is connected to a catholyte solution (a basic solution). A high voltage across the channel will cause ion migration and as a result, establishes a pH gradient across the channel. At the same time, the protein samples will also migrate toward the region along the length of the capillary channel where the local pH is the closest to the protein pI. When the protein reaches its pI, it will have net zero charge and will stop from migrating. This step is called “focusing” step. An image of the channel after all proteins in the sample reach their pI will show the relative abundance of the various protein species in the sample. The pI of the various protein species can be determined by their relative position to pI markers that are added to the sample solution.

While the imaged UV trace gives pI and relative quantitation of the various proteins in the sample, there is a need to be able to identify the protein using a mass spectrometer. This is achieved by mobilizing the proteins. During mobilization, the pH at the catholyte end starts to drop and the protein will start to carry charges which causes it to migrate toward the mobilizer junction. Once it reaches the mobilizer junction, it will be carried by the flowing mobilizer out of the microfluidic chip and sprayed into a mass spec interface. Current cartridge designs do not account for the nanoliter/min flows through the membrane of the pressurized reagent reservoirs present on a microfluidic chip. If this flow is not controlled, the sample can migrate into the catholyte channel, negatively affecting the peak shape and resolutions and subsequent MS analysis.

### SUMMARY

It has been unexpectantly discovered that adjusting, applying, and/or maintaining the pressure in the electrode reservoirs mitigates sample loss by introducing counterflows through the membrane, helps maintain peak shape and resolution, and/or ensuring that downstream analytical characterizations are accurate. This reduction of sample loss helps maintain peak shape and resolution, ensuring that downstream analytical characterizations are accurate.

One aspect of the disclosure is a fixture including at least one electrode reservoir; at least one lid, wherein when the electrode reservoir is sealed with the lid, a positive pressure is applied to and/or maintained in the electrode reservoir generating a pressure-driven flow of a fluid contained within the electrode reservoir; and a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir In another aspect, the flow of the fluid contained within the electrode reservoir to the fluid channel is impeded by the membrane. In yet another aspect, a low flow rate of the fluid contained within the electrode reservoir through the membrane maintained.

One aspect of the disclosure is a fixture including at least one electrode reservoir; at least one lid, wherein when the lid is compressed into the headspace of the electrode reservoir, a positive pressure is applied to and/or maintained in the electrode reservoir generating a pressure-driven flow of a fluid contained within the electrode reservoir; and a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir. In another aspect, the flow of the fluid contained within the electrode reservoir to the fluid channel is impeded by the membrane. In yet another aspect, a low flow rate of the fluid contained within the electrode reservoir through the membrane maintained.

Another aspect of the disclosure is a fixture including: at least one electrode reservoir; at least one lid, and an external pressure source, wherein the lid and/or the electrode reservoir further includes an inlet for an external pressure source, and wherein a positive pressure is applied to and/or maintained in the electrode reservoir using the external pressure source, said positive pressure generating a pressure-driven flow of a fluid contained within the electrode reservoir; and a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir. In another aspect, the flow of the fluid contained within the electrode reservoir to the fluid channel is impeded by the membrane. In yet another aspect, a low flow rate of the fluid contained within the electrode reservoir through the membrane maintained.

In an aspect, the external pressure source is a syringe, a pump, a gas pressure generator, or a pressure control device. In another aspect, the positive pressure within the electrode reservoir is applied and/or maintained using a mechanism configured to regulate and/or control the positive pressure generated by the external pressure source.

In an aspect, the membrane comprises a first surface facing the electrode reservoir and a second surface facing the fluid channel, wherein a hydrodynamic resistance between the first surface and the second surface is equal to or greater than about 40 (N/mm²)/(mm³/s). In another aspect, the hydrodynamic resistance is about 40 (N/mm²)/(mm³/s) to about 62,000 (N/mm²)/(mm³/s). In yet a further aspect, the hydrodynamic resistance is at about 200 (N/mm²)/(mm³/s) to about 12,000 (N/mm²)/(mm³/s).

In an aspect, the low flow rate is a nL/min flow rate. In another aspect, the low flow rate is equal to or less than about 20 nL/min. In yet another aspect, the low flow rate is about 0.2 nL/min to about 20 nL/min. In another aspect, the low flow rate is about 1 nL/min to about 10 nL/min. In yet another aspect, the low flow rate is about 1 nL/min, alternatively about 2 nL/min, alternatively about 3 nL/min, alternatively about 4 nL/min, alternatively about 5 nL/min, alternatively about 8 nL/min, alternatively about 7 nL/min, alternatively about 8 nL/min, alternatively about 9 nL/min, alternatively about 10 nL/min.

In an aspect, the lid comprises a top, a base, and sidewalls, and the width between the sidewalls is less than the width of the top and/or the base. In an aspect, the electrode reservoir comprises a mating bore. In another aspect, the base of the lid is configured to align with the mating bore. In yet another aspect, the base of the lid is irreversibly compressed into the electrode reservoir.

In an aspect, the positive pressure applied and/or maintained in the electrode reservoir is at least about 2 psi. In another aspect, the positive pressure applied and/or maintained in the electrode reservoir is about 2 psi to about 30 psi. In another aspect, the positive pressure applied and/or maintained in the electrode reservoir is about 5 psi to about 15 psi. In yet another aspect, the positive pressure applied and/or maintained in the electrode reservoir is at least about 5 psi, alternatively at least about 6 psi, alternatively at least about 7 psi, alternatively at least about 8 psi, alternatively at least about 9 psi, alternatively at least about 10 psi, alternatively at least about 11 psi, alternatively at least about 12 psi, alternatively at least about 13 psi, alternatively at least about 14 psi, alternatively at least about 15 psi.

In an aspect, the at least one electrode reservoir can be an anolyte reservoir, a catholyte reservoir, or a mobilization reagent reservoir. In one aspect, the fixture includes a catholyte reservoir, and the positive pressure is applied and/or maintained in the catholyte reservoir. In another aspect, the fixture includes an anolyte reservoir, and the positive pressure is applied and/or maintained in the anolyte reservoir. In another aspect, the fixture includes a mobilizer reservoir and the positive pressure is generated and/or maintained in the mobilizer reservoir. In yet another aspect, at least the positive pressure generated and/or maintained in the anolyte reservoir, a catholyte reservoir, or a mobilization reagent reservoir is different than at least another positive pressure generated and/or maintained.

In an aspect, the at least one fluid channel is in fluid communication with a separation channel. In another aspect, the separation channel comprises a lumen of a capillary and/or a fluid channel within a microfluidic device. In yet another aspect, the separation channel is configured to perform isoelectric focusing and/or mobilization.

In an aspect, the fixture further includes an interface configured to receive separation data from the separation channel and a processor coupled to the external pressure source, wherein the processor is configured to execute instructions stored in a memory, wherein execution of the instructions causes the processor to: detect data received from the separation channel during isoelectric focusing and/or mobilization and adjust the pressure supplied from the external pressure source based on the detected data.

One aspect of the disclosure is a fluidic device including at least one fluid inlet; at least one fluid outlet; at least one separation channel comprising a first end that is fluidically coupled to the at least one fluid inlet and a second end that is fluidically coupled to the at least one fluid outlet; and herein the at least one fluid inlet or the at least one fluid outlet is electrically coupled to a high voltage electrode using any one of the disclosed fixtures.

One aspect of the disclosure is a fluidic device including a separation channel; a mobilization channel that intersects with a distal end of the separation channel; at least three electrodes, wherein a first electrode is electrically-coupled to a proximal end of the separation channel, a second electrode is electrically-coupled to the distal end of the separation channel, and a third electrode is electrically-coupled with the mobilization channel; and at least one electrode is electrically coupled to a high voltage electrode using any one of the disclosed fixtures.

In some aspects, the fluidic device may include an additional pressure source coupled to a fluidic channel and/or separation channel. In this aspect, the fixture may be fluidically coupled to the fluidic channel and/or separation channel at a point between the pressure source and fluidic channel and/or separation channel. In an alternative aspect, the fixture may be fluidically coupled to the fluidic channel and/or separation channel via a fluid inlet and/or fluid outlet. The additional pressure source may generate pressures that allows for μL/min flow rates in the fluidic channel and/or separation channel. The additional pressure source may be independently controlled and varied or turned off during the focusing and/or mobilization. In another non-limiting aspect, the additional pressure source may also be coupled to an anolyte, catholyte, and/or mobilization channel

One aspect, is a lid installer comprising an appliance, an aligner and an apparatus, wherein when the fixture is any one of the disclosed fixtures and is placed on the surface of or within the appliance, the aligner is used to align at least one lid and the apparatus is used to straighten and/or seal the at least electrode reservoir with at least one lid.

In an aspect, the aligner is coupled to the appliance. In another aspect, the appliance comprises a cutout substantially similar in size as the fixture. In another aspect, the aligner comprises at least one alignment hole. In yet another aspect, the at least one lid is placed into the alignment hole prior to the use of the apparatus to straighten and/or seal the at least electrode reservoir with at least one lid. In another aspect, the apparatus is placed into the alignment hole to straighten and/or seal the at least electrode reservoir with at least one lid.

One aspect of the disclosure is a method for pressurizing an electrode reservoir including placing any one of the disclosed fixtures fixture on the surface of or within an appliance; placing an aligner on the fixture, wherein the aligner comprises at least one alignment hole; placing at least one lid into the alignment hole; and placing an apparatus into the alignment hole, wherein the apparatus is used to straighten and/or seal the at least electrode reservoir with at least one lid.

### BRIEF DESCRIPTION OF THE DRAWINGS

Aspects of the present disclosure will now be described, by way of example only, with reference to the attached Figures, wherein:

FIG. 1 is a schematic diagram of an iCIEF system, showing the device (top) with the separation channel and the anolyte end as well as the catholyte end of the channel.

FIGS. 2A and 2B are typical iCIEF images. FIG. 2A is UV absorbance vs. detection pixel positions at the end of focusing step. FIG. 2B is a topological view of the focusing and mobilization step. x axis is detector pixel position, y axis is scan number (time). The horizontal red line indicates the start of the mobilization. Below the red line is the focusing step.

FIGS. 3A and 3B illustrate a section of an iCIEF microfluidic chip showing a channel junction between catholyte and separation channels. FIG. 3A shows a sample travel path (red line) in the absence of flow in the catholyte channel toward the tip. FIG. 3B shows a sample travel path (red line) in the presence of flow in the catholyte channel towards the tip.

FIG. 4 compares MS traces with and without a positive pressure at the catholyte reservoir.

FIG. 5 compares UV traces with different pressures at the anolyte reservoir.

FIGS. 6A-6D compares the iCIEF runs with and without pressure control. FIG. 6A is a current trace of a run with pressure control. FIG. 6B is an MS BPE trace of a run with pressure control. FIG. 6C is a current trace of a run without pressure control. FIG. 6D is an MS BPE trace of a run without pressure control.

FIGS. 7 and 7B are illustrations of fixtures according to an aspect of this disclosure.

FIG. 8 shows pressure decay over a 13-hour run time.

FIG. 9 illustrates reservoirs according to an aspect of this disclosure.

FIG. 10 is an example of a fixture including an external pressure source.

### DETAILED DESCRIPTION

Unless otherwise defined, all technical and scientific terms used herein have the same meaning as commonly understood by one of ordinary skill in the art to which the methods described herein belong.

The singular form “a,” “an” and “the” include plural referents unless the context clearly dictates otherwise. These articles refer to one or to more than one (i.e., to at least one). The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z.”

The term “about” as used in connection with a numerical value throughout the specification and the claims denotes an interval of accuracy, familiar and acceptable to a person skilled in the art. In general, such interval of accuracy is +/−10%.

Where ranges are given, endpoints are included. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

The term “exemplary” means serving as a non-limiting example, instance, or illustration. As utilized herein, the terms “e.g.,” and “for example” set off lists of one or more non-limiting aspects, examples, instances, or illustrations.

Isoelectric focusing (or “electrofocusing”) is a technique for separating molecules by differences in their isoelectric point (pI), i.e., the pH at which the molecules have a net zero charge. iCIEF involves adding ampholyte (amphoteric electrolyte) solutions to a sample channel between reagent reservoirs containing an anode or a cathode to generate a pH gradient within a separation channel (i.e., the fluid channel connecting the electrode-containing wells, e.g., the lumen of a capillary or a channel in a microfluidic device) across which a separation voltage is applied. The ampholytes can be solution phase or immobilized on the surface of the channel wall. Negatively charged molecules migrate through the pH gradient in the medium toward the positive electrode while positively charged molecules move toward the negative electrode.

A protein (or other molecule) that is in a pH region below its isoelectric point (pI) will be positively charged and so will migrate towards the cathode (i.e., the negatively charged electrode). The protein's overall net charge will decrease as it migrates through a gradient of increasing pH (due, for example, to protonation of carboxyl groups or other negatively charged functional groups) until it reaches the pH region that corresponds to its pI, at which point it has no net charge and so migration ceases. As a result, a mixture of proteins separates based on their relative content of acidic and basic residues and becomes focused into sharp stationary bands with each protein positioned at a point in the pH gradient corresponding to its pI. The technique is capable of extremely high resolution, with proteins differing by a single charge being fractionated into separate bands. In some embodiments, isoelectric focusing may be performed in a separation channel that has been permanently or dynamically coated, e.g., with a neutral and hydrophilic polymer coating, to eliminate electroosmotic flow (EOF).

The pH gradient used for capillary isoelectric focusing techniques is generated through the use of ampholytes, i.e., amphoteric molecules that contain both acidic and basic groups and that exist mostly as zwitterions within a certain range of pH. The portion of the electrolyte solution on the anode side of the separation channel is known as an “anolyte”. That portion of the electrolyte solution on the cathode side of the separation channel is known as a “catholyte”. A variety of electrolytes may be used in the disclosed methods and devices including, but not limited to, phosphoric acid, sodium hydroxide, ammonium hydroxide, glutamic acid, lysine, formic acid, dimethylamine, triethylamine, acetic acid, piperidine, diethylamine, and/or any combination thereof. The electrolytes may be used at any suitable concentration, such as 0.0001%, 0.001%, 0.01%, 0.1%, 1%, 10%, 20%, 30%, 40%, 50%, 60%, 70%, 80%, 90%, etc. The concentration of the electrolytes may be at least 0.0001%, 0.001%, 0.01%, 0.1%, 1%, 10%, 20%, 30%, 40%, 50%, 60%, 70%, 80%, 90%. The concentration of the electrolytes may be at most 90%, 80%, 70%, 60%, 50%, 40%, 30%, 20%, 10%, 1%, 0.1%, 0.01%, 0.001%, 0.0001%.

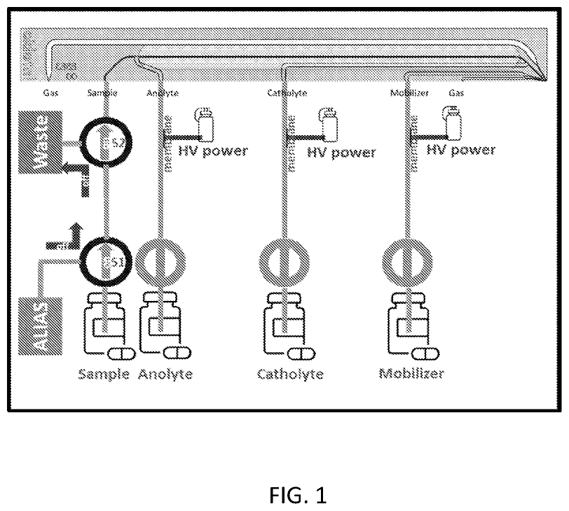

FIG. 1 is a schematic diagram of an iCIEF system.

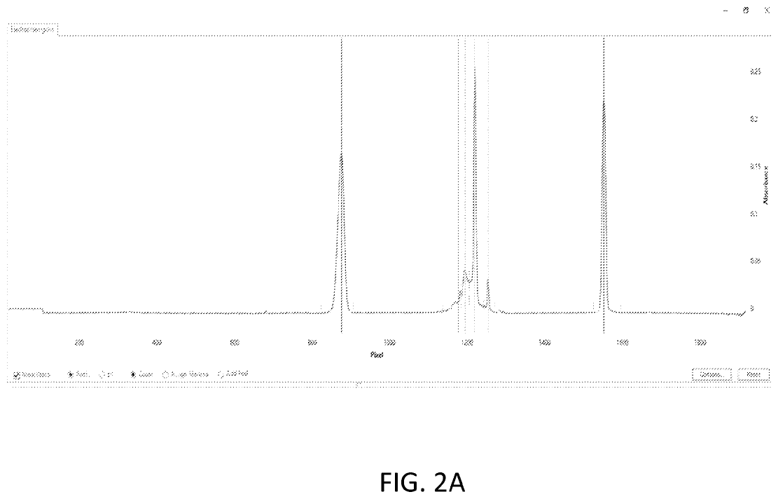

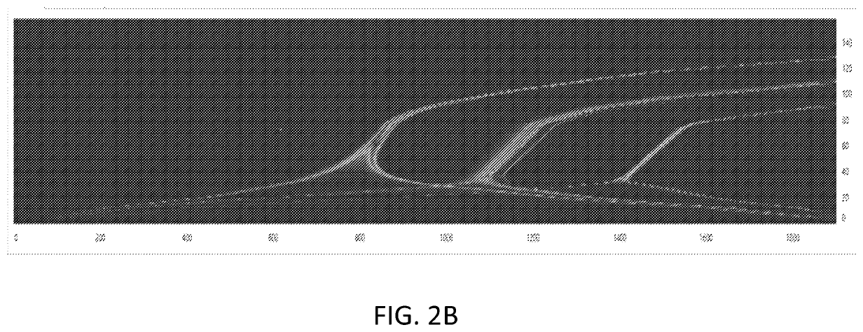

While the imaged UV trace gives pI and relative quantitation of the various proteins in the sample, there is still a need to be able to identify the protein using a mass spectrometer. This is achieved by mobilizing the proteins. During mobilization, the pH at the catholyte end starts to drop, and the protein will start to carry charges which causes it to migrate toward the mobilizer junction. Once it reaches the mobilizer junction, it will be carried by the flowing mobilizer out of the microfluidic chip and sprayed into a mass spec interface (FIGS. 2A and 2B).

Some aspects of the disclosure include a fixture with at least one electrode reservoir, and a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir. The fluid flow from the electrode reservoir through the membrane impacts peak shape during focusing and/or mobilization. The disclosed fixtures and fluidic devices are designed to control the fluid flow within the electrode reservoir, thereby producing resolved peaks during separation, focusing and/or mobilization.

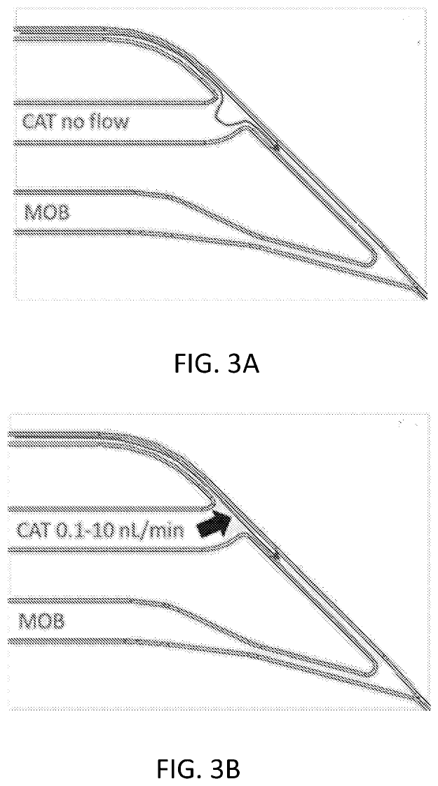

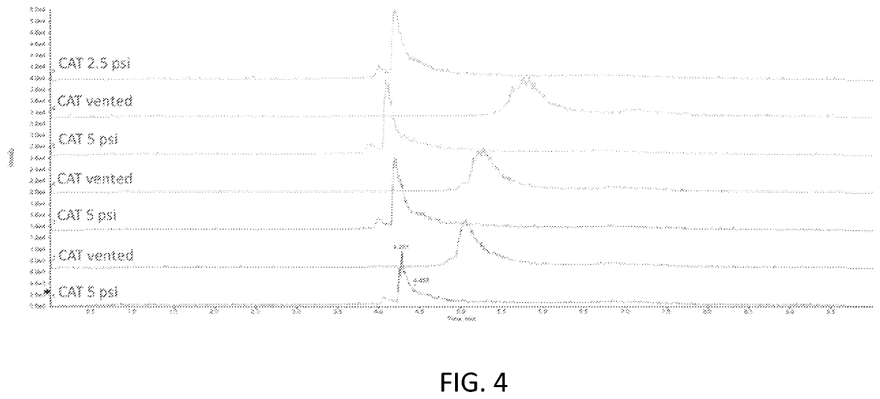

It is important to keep the iCIEF peak shape and resolution during the separation, focusing and/or mobilization process. In previous designs, the flow rate from the electrode channel was assumed to be zero due to the high hydrodynamic resistance of the membrane to cut off hydrodynamic flow between the reservoir and the channel. However, it is discovered that a small flow from an electrode reservoir toward the separation channel is beneficial to maintain the peak shape and resolution. FIG. 3 is a zoomed-in section of an iCIEF microfluidic chip, showing the junction between the catholyte and separation channels and the electrical field line during the mobilization process. As shown in FIG. 4, a comparison of MS traces with and without a positive pressure at the catholyte reservoir, the peak shape can be significantly compromised when the reservoir is vented (i.e., no positive pressure).

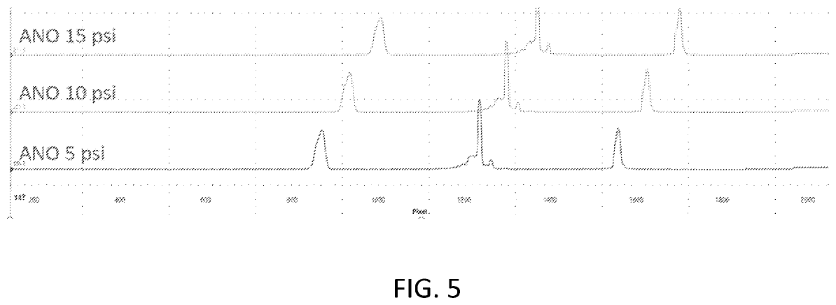

Pressure also has an impact on IEF focusing position and drift. As shown in FIG. 5, the focusing position of the peaks steadily shifts to the basic end as the pressure increases. For example, from 5 psi to 15 psi, the marker and protein peak drift to the right side by 133 pixels. The flow rate=(133 pixels)*(25 μm/pixels)*(140 μm channel width)*(40 μm channel depth)/(15-5 psi)/8 min=0.23 nL/min/psi or 3.5 nL/min at 1 atmospheric pressure. The hydrodynamic resistance is 0.22 (bar)/(nL/min) or 1.32×10³ ((N/mm²)/(mm³/s)). Maintaining a positive pressure within an electrode reservoir is necessary to achieve resolve peaks and limit drift.

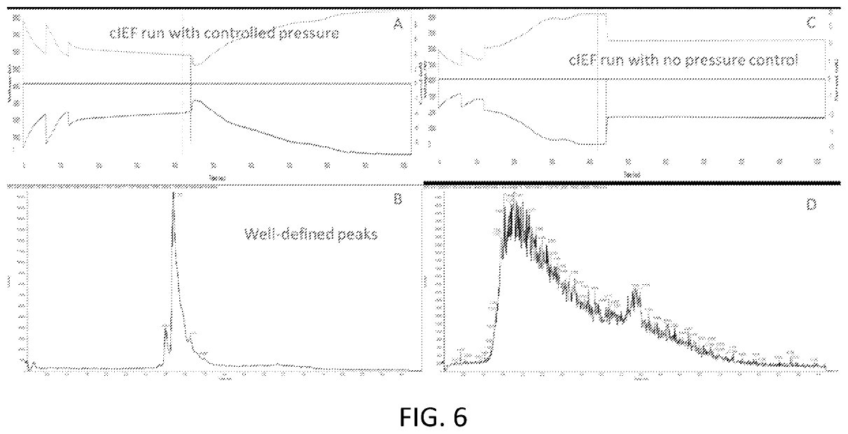

The ability to control nanoliter scale flows through a microfluidic device is also a factor in peak resolution. The lack of control over the flows of a microfluidic chip leads to the unwanted mixing of the reagents (aka backflow) during the run and manifests itself through abnormal current profiles (e.g., FIG. 6A). As shown in FIGS. 6A-6D , this unwanted reagent backflow results in runs with no valuable UV/MS data and wastes samples and instrument time.

As already demonstrated, the pressure control of the reservoirs allows to control the resolution of the peaks that directly impact both the focusing position of species in iCIEF and BPE peak shape in MS. The focusing position in iCIEF impact the reproducibility from run to run and ensures that the focused species are correctly identified in MS. Controlling the focusing position allows to reduce the total run time by focusing the species closer to the basic end of the chip so it takes a shorter time to mobilize from the chip to MS. This can improve the total throughput of the system by at least 5%. BPE peak shape allows better separation of species in MS and thus allows for identifying species in MS with a higher degree of confidence.

One aspect of the disclosure is a fixture (also known as a cartridge) design that is able to generate and maintain positive reservoir pressure in an electrode reservoir. By controlling the pressure within the electrode reservoirs, a hydrodynamic resistance between a first surface facing the electrode reservoir and a second surface facing the fluid channel can be achieved, which, in turn, allows for a low flow rate of the fluid contained within the electrode reservoir through the membrane.

In a non-limiting example, a hydrodynamic resistance between the first and second surfaces is equal to or greater than about 40 (N/mm²)/(mm³/s). The hydrodynamic resistance may also be a range of about 40 (N/mm²)/(mm³/s) to about 62,000 (N/mm²)/(mm³/s), alternatively at least about 200 (N/mm²)/(mm³/s) to about 12,000 (N/mm²)/(mm³/s).

In some aspects, the flow rate is a speed at which the fluid contained within the electrode reservoir moved from the reservoir through the membrane. A low flow rate is a flow rate that delivers small amounts of fluid per unit of time. A low flow rate may encompass a micro flow or a nano flow. In some non-limiting aspects, the flow rate may be an ultra-low flow rate. In some aspects, the low flow rate is a nL/min flow rate. In non-limiting examples, the low flow rate is equal to or less than about 20 nL/min. The low flow rate may also range from about 0.2 nL/min to about 20 nL/min, alternatively about 1 nL/min to about 10 nL/min. The low flow rate may also be about 1 nL/min, alternatively about 2 nL/min, alternatively about 3 nL/min, alternatively about 4 nL/min, alternatively about 5 nL/min, alternatively about 8 nL/min, alternatively about 7 nL/min, alternatively about 8 nL/min, alternatively about 9 nL/min, alternatively about 10 nL/min.

One non-limiting example of a fixture that can generate positive pressure in an electrode reservoir includes at least one electrode reservoir; at least one lid, wherein when the electrode reservoir is sealed with the lid, a positive pressure is applied to and/or maintained in the electrode reservoir generating a pressure-driven flow of a fluid contained within the electrode reservoir; and a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir. In some examples the flow of the fluid contained within the electrode reservoir to the fluid channel is impeded by the membrane. In a non-limiting example, the membrane impedes the flow of the fluid contained within the electrode reservoir delaying, blocking, and/or hindering the movement of the fluid from the electrode reservoir to the fluid channel. In other examples, a flow rate of the fluid contained within the electrode reservoir through the membrane maintained.

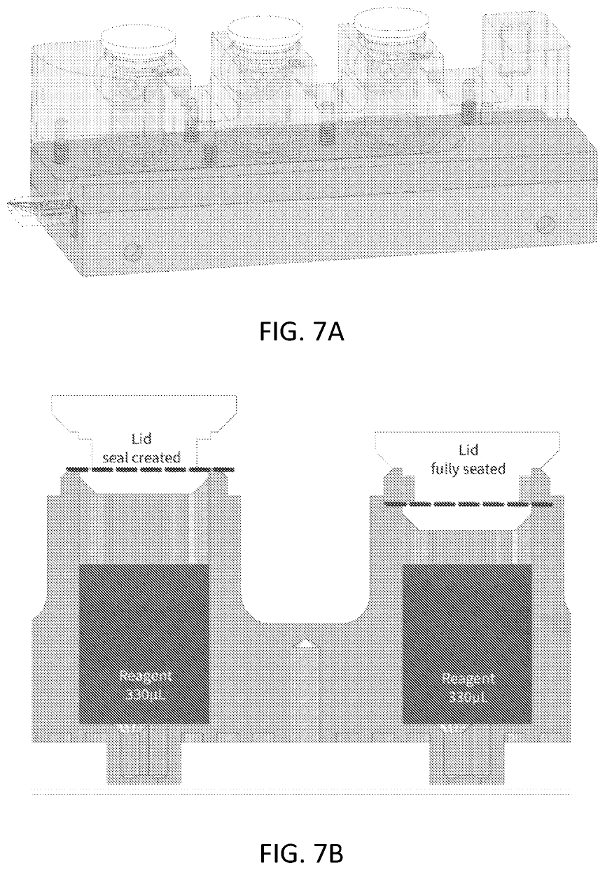

As shown in FIGS. 7A and 7B, the pressure in the reservoir is created by a lid compressing the air. In this aspect, the user installs a lid on each reservoir. The action of installing the lid both pressurizes and seals the reservoir. The assembly is designed to align the lid with its mating bore on the reservoir, create a leak-resistant seal, and generate between 10 psi to 15 psi within the reservoir when fully seated. The pressure generated may also depend on the size of the lid and/or reservoir, and the lid's geometry is designed to displace sufficient volume when installed to reach the target pressures.

In other non-limiting examples, the pressure generated may be at least about 2 psi. The pressure generated may also fall within a range including about 2 psi to about 30 psi or alternatively about 5 psi to about 15 psi. The pressure generated may also be at least about 5 psi, alternatively at least about 6 psi, alternatively at least about 7 psi, alternatively at least about 8 psi, alternatively at least about 9 psi, alternatively at least about 10 psi, alternatively at least about 11 psi, alternatively at least about 12 psi, alternatively at least about 13 psi, alternatively at least about 14 psi, alternatively at least about 15 psi.

FIGS. 7A and 7B are one aspect of the disclosure that shows three reservoirs and lids on the assembly. However, it is appreciated that the fixture may include 1 reservoir, 2 reservoirs, 4 reservoirs, or 5 or more reservoirs. The reservoirs may be an anolyte reservoir, a catholyte reservoir, or a mobilization reagent reservoir, each of which may be independently controlled. For example, the fixture may include an anolyte reservoir and the positive pressure is applied and/or maintained in the anolyte reservoir. The fixture may include a catholyte reservoir, and the positive pressure is applied and/or maintained in the the catholyte reservoir. The fixture may alternatively include a mobilizer reservoir and the positive pressure is generated and/or maintained in the mobilizer reservoir. In some non-limiting examples, the positive pressure generated and/or maintained in the anolyte reservoir, a catholyte reservoir, or a mobilization reagent reservoir is different than at least another positive pressure generated and/or maintained.

FIG. 7B shows the lid's starting position when it first generates a seal and the final position where it has reached maximum pressure. In this aspect, the assembly is designed to reach the target pressures with a reagent fill volume of 330 μL.

In some aspects, the lid can be installed on the reservoir using a tool, such as a lid installer. In a non-limiting example, the lid installer may include an appliance, an aligner, and an apparatus, wherein when a fixture is placed on the surface of or within the appliance, the aligner is used to align at least one lid, and the apparatus is used to straighten and/or seal the at least electrode reservoir with at least one lid. For ease of use, the aligner may be coupled to the appliance and/or the appliance includes a cutout substantially similar in size to the fixture.

In some aspects, the aligner may also include at least one alignment hole. The alignment hole may allow a user to place a lid into the alignment hole prior to using the apparatus to straighten and/or seal the at least electrode reservoir with at least one lid. After the lid is aligned, the apparatus may be placed into the alignment hole to straighten and/or seal the at least electrode reservoir with at least one lid. Another non-limiting aspect of the disclosure is a method for pressurizing an electrode reservoir, including placing a fixture on the surface of or within an appliance; placing an aligner on the fixture, wherein the aligner comprises at least one alignment hole; placing at least one lid into the alignment hole; and placing an apparatus into the alignment hole, wherein the apparatus is used to straighten and/or seal the at least electrode reservoir with at least one lid.

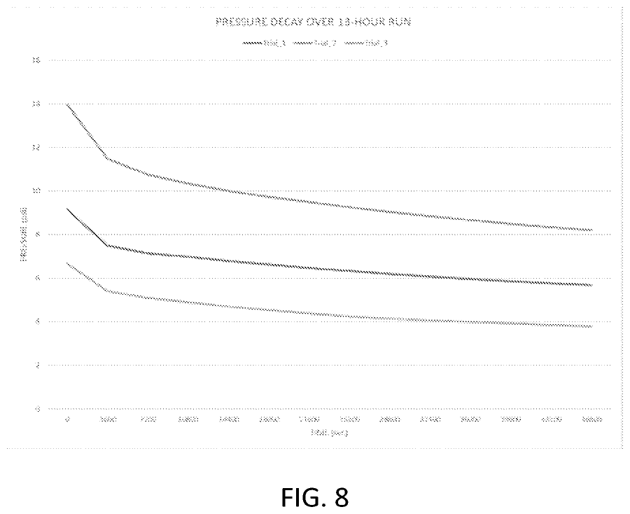

The reservoir seal is designed to minimize leakage with a target leakage rate of less than 0.15 psi/hour. This achieves the desired minimum pressure drop of 2 psi over the expected analysis run time of 13 hours. FIG. 8 shows an example of pressure decay.

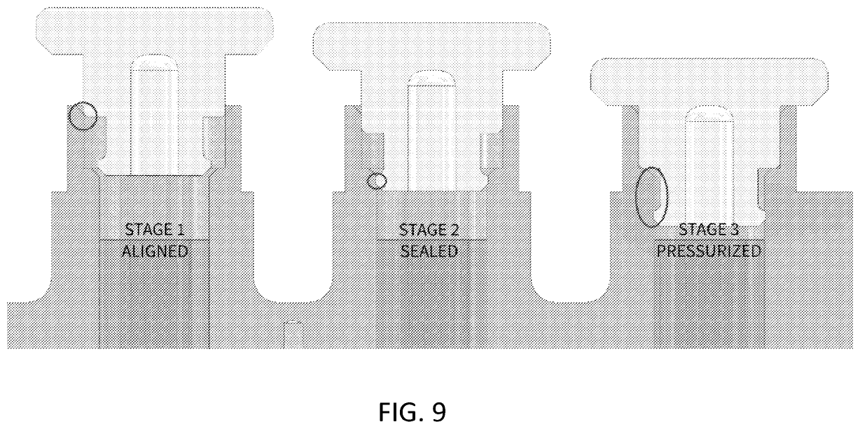

FIG. 9 is another illustration of an aspect of this disclosure. Here all three phases of operation can be seen. In stage 1 (left) the lid alignment features engage the reservoir block to ensure correct positioning prior to insertion. Stage 2 (center) shows the seal feature fully engaged with the reservoir bore, creating a leak resistant seal. In stage 3 (right) the lid is fully inserted until it stops, generating the pressure necessary to optimize reagent flow for analysis.

Another non-limiting example of a fixture that can generate positive pressure in an electrode reservoir included at least one electrode reservoir; at least one lid, and an external pressure source, wherein the lid and/or the electrode reservoir further comprises an inlet for an external pressure source, and wherein a positive pressure is applied to and/or maintained in the electrode reservoir using the external pressure source, said positive pressure generating a pressure-driven flow of a fluid contained within the electrode reservoir; and a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir. In a further example, the flow of the fluid contained within the electrode reservoir to the fluid channel is impeded by the membrane. In another example, a flow rate of the fluid contained within the electrode reservoir through the membrane maintained.

When an external pressure source is used, it can be any external pressure source commonly used to pressurize containers. Non-limiting examples include a syringe, a pump, a gas pressure generator, or a pressure control device. The positive pressure generated by the external pressure source within the electrode reservoir may be applied and/or maintained using a mechanism configured to regulate and/or control the positive pressure generated by the external pressure source.

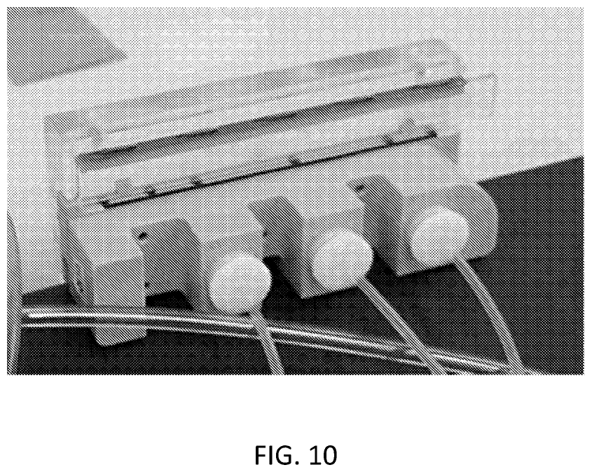

As shown in FIG. 10, the pressure in reservoirs can be controlled together or individually, having tubing coming through the reservoir lids and delivering air pressure supplied by an external regulator. In this non-limiting example, using an external pressure source will eliminate the initial rapid pressure decay phase as shown in FIG. 8 and improve the accuracy of pressure control. As a result, the run-to-run reproducibility in terms of focusing position and MS arrival time.

Having a stable reservoir pressure is essential for the development of the fluidic devices or cartridges that could sustain a large number of runs (100+) as the pressure generated by a lid compressing the air in reservoirs inevitably decays over time, and the pressure in reservoirs at any given time will vary from cartridge to cartridge.

In some non-limiting aspects, at least one fluid channel of the fixture is in fluid communication with a separation channel. In some aspects, the separation channel may include a lumen of a capillary and/or a fluid channel within a microfluidic device. In these aspects, the fixture may be configured to perform one or more separation or enrichment steps in which a plurality of analytes in a mixture are separated and/or concentrated in individual fractions. For example, in some instances, the disclosed fixtures may be configured to perform a first enrichment step, in which a mixture of analytes in a sample are separated into and/or enriched as analyte fractions (e.g., analyte peaks or analyte bands) containing a subset of the analyte molecules from the original sample. In some instances, these separated analyte fractions may be mobilized and/or eluted, and in some instances, may then be subjected to another downstream separation and/or enrichment step. In some instances, e.g., following a final separation and/or enrichment step, the separated/enriched analyte fractions may be expelled from the device for further analysis.

In some aspects, the fixture may be part of a fluidic device configured to perform isoelectric focusing and/or mobilization. In these non-limiting aspects, the fluidic device may include at least one fluid inlet; at least one fluid outlet; at least one separation channel comprising a first end that is fluidically coupled to the at least one fluid inlet, and a second end that is fluidically coupled to the at least one fluid outlet; and wherein the at least one fluid inlet or the at least one fluid outlet is electrically coupled to a high voltage electrode using the fixture.

In another aspect, the fixture may be part of a fluidic device that includes a separation channel; a mobilization channel that intersects with a distal end of the separation channel; at least three electrodes, wherein a first electrode is electrically-coupled to a proximal end of the separation channel, a second electrode is electrically-coupled to the distal end of the separation channel, and a third electrode is electrically-coupled with the mobilization channel; and at least one electrode is electrically coupled to a high voltage electrode using the fixture.

The method implemented by the fluidic device may further comprise elution of the analyte species from a separation channel or from a plurality of separation channels (e.g., by simultaneously or independently changing a buffer that flows through each a plurality of separation channels), which may be referred to as a “mobilization” step or reaction. In some instances, the method implemented by the fluidic device may further include simultaneously or independently applying pressure to a of separation channel, or simultaneously or independently introducing an electrolyte into a separation channel to disrupt the pH gradient used for isoelectric focusing, and thus trigger migration of the separated analyte peaks out of the separation channels, which may also be referred to as a “mobilization” step. In some aspects, the pressure used to drive separation and/or mobilization is different than the pressure used to apply and/or maintain positive pressure in the reservoir.

In some instances, the force used to drive the separation reactions (e.g., isoelectric focusing reactions) may be turned off during the mobilization step. In some instances, the force used to drive the separation reactions may be left on during the mobilization step. In some instances of the disclosed methods, e.g., those including an isoelectric focusing step, the separated analyte bands may be mobilized (e.g., using hydrodynamic pressure and/or a chemical mobilization technique) such that the separated analyte bands migrate towards an end of a separation channel.

In some instances, mobilization of the analyte bands may be implemented by simultaneously or independently applying hydrodynamic pressure to one end of the separation channel. In some instances, mobilization of the analyte bands may be implemented by orienting the device such that the separation channel is in a vertical position so that gravity may be employed. In some instances, mobilization of the analyte bands may be implemented using EOF-assisted mobilization. In some instances, mobilization of the analyte bands may be implemented using chemical mobilization, e.g., by simultaneously or independently introducing a mobilization electrolyte into the separation channel that shifts the local pH in a pH gradient used for isoelectric focusing. In some instances, any combination of these mobilization techniques may be employed.

In some instances, the positive pressure in the electrode reservoir may be adjusted based on data derived from the separation channel. In a non-limiting example, the data may be derived from images (e.g., automated image processing) of the separation channel as separation reactions are performed and/or separations occur. In this aspect, the image-derived data may be used to monitor the presence or absence of one or more analyte peaks, the positions of one or more analyte peaks, the widths of one or more analyte peaks, the velocities of one or more analyte peaks, separation resolution, a rate of change or lack thereof in the presence, position, width, or velocity of one or more analyte peaks, or any combination thereof, and may be used to determine whether a separation reaction is complete, to trigger the initiation of a mobilization step in a given separation channel, and/or adjust the pressure supplied from the external pressure source based on the detected data.

In a non-limiting example, a fluidic device may include an interface configured to receive data from the separation channel and a processor coupled to the external pressure source, wherein the processor is configured to execute instructions stored in a memory, wherein execution of the instructions causes the processor to detect data received from the separation channel during isoelectric focusing and/or mobilization and adjust the pressure supplied from the external pressure source based on the detected data.

In an aspect, the disclosed fixtures may be integrated with an analytical instrument, e.g., an ESI interface for performing mass spectrometry on the separated analytes. In these aspects, mobilized analytes can be expelled from a fluidic device via electrospray ionization into a mass spectrometer. In some examples, the separation data can be correlated with data received from a downstream analytical characterization instrument. In some aspects, peaks detected in the separation channel may be correlated with mass spectrometer data generated for the separated analytes.

### EXAMPLES

### Exemplary Workflow

Vials with electrolytes (water, anolyte, catholyte, and mobilizer) are installed onto a sample manifold. The rinse cartridge is installed onto a fluidic device and all the electrolyte vials are purged.

330 μL of the anolyte solution is aspirated and dispensed into the anolyte reservoir on the fixture, 330 μL of the catholyte solution is aspirated and dispensed into the catholyte reservoir on the fixture, and 330 μL of the mobilizer solution is aspirated and dispensed into the mobilizer reservoir on a fixture. To push any air bubbles out of the bottom of the reservoirs while dispensing, the syringe or pipettor was placed in contact with one of the holes in the bottom of the reservoir.

The fixture was placed into a lid installer that has an appliance, an aligner, and an apparatus and the aligner was closed over open reservoirs. Caps were dropped into holes of the aligner and sit presser on them to self-align caps to holes. The apparatus was lifted and it was checked that the caps are flatly in holes. The apparatus was replaced in the aligner and firmly pushed down to evenly press lids into cartridge reservoirs.

The fixture was installed on the fluidic device. The holes on the bottom of the fluidic device align with the ports and pins on the mount of the fixture.

The fixture was locked in place with the clamp. Lasers that point at the end of the fluidic device were turned on. The nebulizer gas pressure was set to desired psi, and then nebulizer gas flow was turned on. The fixture was primed. Automatic priming flushes the fixture with electrolytes forcing the air bubbles through the tip.

The sample vials were installed in an autosampler noting the position and the software was initiated specifying the sample position. The system primed the fixture with the electrolytes and the autosampler aspirates the sample from the target vial and loaded it onto the fluidic device.

After loading the sample, the instrument flowed the catholyte for 15 s to form a catholyte cap that protects the pH gradient and allow the focusing to occur. The instrument then flowed mobilizer at 1-1.3 μL/min. Initially, 1500V was applied to the anolyte electrode with the ground being the catholyte electrode for 60 s to start the focusing process. The voltage was then changed to 3000V for 6 s and then to 4500V and kept for 300 s. By the end of this time period the sample was completely focused.

After 420 s, the instrument applied 8500V for 600 s to the anolyte electrode with the ground being the mobilizer electrode to start the mobilization process. During this time the sample migrated out of the separation channel of the fluidic device and was picked up by the mobilizer flow. The sample in the mobilizer was then sprayed out of the open fluidic device tip and into the mass spectrometer. After the run, the fluidic device was washed with electrolytes.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

It will be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A fixture comprising:
at least one electrode reservoir;
at least one lid,
wherein when the electrode reservoir is sealed with the lid, a positive pressure is applied to and/or maintained in the electrode reservoir generating a pressure-driven flow of a fluid contained within the electrode reservoir; and
a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir.

2. A fixture comprising:
at least one electrode reservoir;
at least one lid, and
an external pressure source, wherein the lid and/or the electrode reservoir further comprises an inlet for an external pressure source,
and wherein a positive pressure is applied to and/or maintained in the electrode reservoir using the external pressure source, said positive pressure generating a pressure-driven flow of a fluid contained within the electrode reservoir; and
a membrane disposed at a surface of the electrode reservoir, the membrane providing an electrical connection between an electrode positioned within the electrode reservoir, the fluid contained within the electrode reservoir, and at least one fluid channel in fluid communication with the electrode reservoir.

3. The fixture of claim 1 or claim 2, wherein the flow of the fluid contained within the electrode reservoir to the fluid channel is impeded by the membrane.

4. The fixture of any one of the preceding claims, wherein a low flow rate of the fluid contained within the electrode reservoir through the membrane maintained.

5. The fixture of claim 2 or claim 3, wherein the external pressure source is a syringe, a pump, a gas pressure generator, or a pressure control device.

6. The fixture of any one of claims 2 to 4, wherein the positive pressure within the electrode reservoir is applied and/or maintained using a mechanism configured to regulate and/or control the positive pressure generated by the external pressure source.

7. The fixture of any one of the preceding claims, wherein the membrane comprises a first surface facing the electrode reservoir and a second surface facing the fluid channel, wherein a hydrodynamic resistance between the first surface and the second surface is equal to or greater than about 40 (N/mm²)/(mm³/s).

8. The fixture of claim 7, wherein the hydrodynamic resistance is about 40 (N/mm²)/(mm³/s) to about 62,000 (N/mm²)/(mm³/s).

9. The fixture of claim 8, wherein the hydrodynamic resistance is at least about 200 (N/mm²)/(mm³/s) to about 12,000 (N/mm²)/(mm³/s).

10. The fixture of any one of the preceding claims, wherein the low flow rate is a nL/min flow rate.

11. The fixture of claim 10, wherein the low flow rate is equal to or less than about 20 nL/min.

12. The fixture of claim 11, wherein the low flow rate is about 0.2 nL/min to about 20 nL/min.

13. The fixture of claim 12, wherein the low flow rate is about 1 nL/min to about 10 nL/min.

14. The fixture of claim 13, wherein the low flow rate is about 1 nL/min, alternatively about 2 nL/min, alternatively about 3 nL/min, alternatively about 4 nL/min, alternatively about 5 nL/min, alternatively about 8 nL/min, alternatively about 7 nL/min, alternatively about 8 nL/min, alternatively about 9 nL/min, alternatively about 10 nL/min.

15. The fixture of any one of the preceding claims, wherein the lid comprises a top, a base, and sidewalls, and the width between the sidewalls is less than the width of the top and/or the base.

16. The fixture of any one of the preceding claims, wherein the electrode reservoir comprises a mating bore.

17. The fixture of claim 16, wherein the base of the lid is configured to align with the mating bore.

18. The fixture of any one of the preceding claims, wherein the positive pressure applied and/or maintained in the electrode reservoir is at least about 2 psi.

19. The fixture of any one of 17, wherein the positive pressure applied and/or maintained in the electrode reservoir is about 2 psi to about 30 psi.

20. The fixture of claim 19, wherein the positive pressure applied and/or maintained in the electrode reservoir is about 5 psi to about 15 psi.

21. The fixture of claim 20, wherein the positive pressure applied and/or maintained in the electrode reservoir is at least about 5 psi, alternatively at least about 6 psi, alternatively at least about 7 psi, alternatively at least about 8 psi, alternatively at least about 9 psi, alternatively at least about 10 psi, alternatively at least about 11 psi, alternatively at least about 12 psi, alternatively at least about 13 psi, alternatively at least about 14 psi, alternatively at least about 15 psi.

22. The fixture of any one of the preceding claims, wherein the at least one electrode reservoir is an anolyte reservoir, a catholyte reservoir, or a mobilization reagent reservoir.

23. The fixture of any one of the preceding claims, wherein the fixture comprises a catholyte reservoir, and the positive pressure is applied and/or maintained in the catholyte reservoir.

24. The fixture of any one of the preceding claims, wherein the fixture comprises an anolyte reservoir, and the positive pressure is applied and/or maintained in the anolyte reservoir.

25. The fixture of any one of the preceding claims, wherein the fixture comprises a mobilizer reservoir and the positive pressure is generated and/or maintained in the mobilizer reservoir.

26. The fixture of any one of claims 22 to 23, wherein at least the positive pressure generated and/or maintained in the anolyte reservoir, a catholyte reservoir, or a mobilization reagent reservoir is different than at least another positive pressure generated and/or maintained.

27. The fixture of any one of the preceding claims, wherein the at least one fluid channel is in fluid communication with a separation channel.

28. The fixture of claim 27, wherein the separation channel comprises a lumen of a capillary and/or a fluid channel within a microfluidic device.

29. The fixture of claim 27 or claim 28, wherein the separation channel is configured to perform isoelectric focusing and/or mobilization.

30. The fixture of claim 29, further comprising an interface configured to receive data from the separation channel and a processor coupled to the external pressure source, wherein the processor is configured to execute instructions stored in a memory, wherein execution of the instructions causes the processor to: detect data received from the separation channel during isoelectric focusing and/or mobilization and adjust the pressure supplied from the external pressure source based on the detected data.

31. A fluidic device comprising:
at least one fluid inlet;
at least one fluid outlet;
at least one separation channel comprising a first end that is fluidically coupled to the at least one fluid inlet and a second end that is fluidically coupled to the at least one fluid outlet; and
wherein the at least one fluid inlet or the at least one fluid outlet is electrically coupled to a high voltage electrode using a fixture of any one of the preceding claims.

32. A fluidic device comprising:
a separation channel;
a mobilization channel that intersects with a distal end of the separation channel;
at least three electrodes,
wherein a first electrode is electrically-coupled to a proximal end of the separation channel,
a second electrode is electrically-coupled to the distal end of the separation channel,
and a third electrode is electrically-coupled with the mobilization channel;
and at least one electrode is electrically coupled to a high voltage electrode using a fixture of any one of claims 1 to 28.

33. A lid installer comprising an appliance, an aligner and an apparatus, wherein when the fixture of any one of claims 1 to 28 is placed on the surface of or within the appliance, the aligner is used to align at least one lid and the apparatus is used to straighten and/or seal the at least electrode reservoir with at least one lid.

34. The lid installer of claim 33, wherein the aligner is coupled to the appliance.

35. The lid installer of claim 33 or claim 34, wherein the appliance comprises a cutout substantially similar in size as the fixture.

36. The lid installer of any one of claims 33 to 35, wherein the aligner comprises at least one alignment hole.

37. The lid installer of claim 36, wherein the at least one lid is placed into the alignment hole prior to the use of the apparatus to straighten and/or seal the at least electrode reservoir with at least one lid.

38. The lid installer of claim 36 or claim 37, wherein the apparatus is placed into the alignment hole to straighten and/or seal the at least electrode reservoir with at least one lid.

39. A method for pressurizing an electrode reservoir comprising:
placing a fixture of any one of claims 1 to 28 on the surface of or within an appliance;
placing an aligner on the fixture, wherein the aligner comprises at least one alignment hole;
placing at least one lid into the alignment hole; and
placing an apparatus into the alignment hole, wherein the apparatus is used to straighten and/or seal the at least electrode reservoir with at least one lid.
